(19) United States
(12) Patent Application Publication
(10) Pub. No.: US 2022/0397484 A1
(43) Pub. Date: Dec. 15, 2022

(54) VIBRATION ANALYSIS APPARATUS AND VIBRATION MEASUREMENT SYSTEM

(71) Applicant: NTN Corporation, Osaka (JP)

(72) Inventor: Masaya TOMINAGA, Kuwana-shi, Mie (JP)

(21) Appl. No.: 17/765,350

(22) PCT Filed: Sep. 24, 2020
(86) PCT No.: PCT/JP2020/035984

§ 371 Date: Mar. 30, 2022

(30) Foreign Application Priority Data
Oct. 2, 2019 (JP) 2019-181804
Oct. 7, 2019 (JP) 2019-184541

(51) Int. Cl. G01M 13/045; G01H 1/00

(52) U.S. Cl. CPC G01M 13/045; G01H 1/003

(57) ABSTRACT

For peaks having top ten peak values in a frequency spectrum obtained by frequency analysis, a central processing unit specifies a part based on information on a bearing subjected to measurement. For the peaks having the top ten peak values, a determination unit determines a vibration state based on the peak value and a criterion value. For the peaks having the top ten peak values, a display shows the peak value, the part, and a result of determination by the determination unit.

### TECHNICAL FIELD

The present invention relates to a vibration analysis apparatus and a vibration measurement system, and particularly to a vibration analysis apparatus that receives measurement data from a measurement instrument that measures vibration of a rotating body subjected to measurement and conducts vibration analysis and a vibration measurement system including the same.

### BACKGROUND ART

Japanese Patent Laying-Open No. 2016-24007 (PTL 1) discloses a system for diagnosing a rolling bearing or the like. In this diagnosis system, an information terminal transmits to a server, measurement data provided from a vibration sensor, a model number of a diagnosis target, and data on a rotation speed in measurement. The server diagnoses an abnormal condition of the rolling bearing or the like based on the measurement data and sends a result of diagnosis back to the information terminal. In the server, specification data (spec data) of the diagnosis target is held for each model number, and the server processes the received measurement data with the use of the specification data corresponding to the received model number and the received data on the rotation speed, and sends a result of diagnosis back to the information terminal. Then, the information terminal shows the result of diagnosis sent back from the server (see PTL 1).

U.S. Pat. No. 7,587,299 (PTL 2) discloses an anomaly diagnosis method of diagnosing an anomaly of a bearing used with a machine installation. In this anomaly diagnosis method, only a frequency component caused by an anomaly in the bearing is extracted. Specifically, frequencies of an inner ring flaw component, an outer ring flaw component, a rolling element flaw component, and a cage component are extracted. The frequency component is calculated based on an inner ring rotation speed, a diameter of a rolling element, a pitch circle diameter, the number of rolling elements, and a contact angle. Then, anomaly diagnosis is conducted based on the magnitude of the extracted frequency component (see PTL 2).

### CITATION LIST

### Patent Literature

PTL 1: Japanese Patent Laying-Open No. 2016-24007

PTL 2: U.S. Pat. No. 7,587,299

### SUMMARY OF INVENTION

### Technical Problem

In the diagnosis system described in PTL 1, the server conducts diagnosis, and the result of diagnosis sent back from the server is shown on the information terminal. Therefore, a user can check the result of diagnosis on the information terminal. PTL 1, however, does not particularly discuss how to show the result of diagnosis on the information terminal. Intelligibly showing the result of diagnosis to the user who uses the information terminal contributes to improvement in convenience of such a diagnosis system.

In the anomaly diagnosis method described in PTL 2, anomaly diagnosis is conducted only for a frequency component (the inner ring flaw component, the outer ring flaw component, the rolling element flaw component, and the cage component) produced by an anomaly of the bearing. Therefore, diagnosis is not conducted for other anomalies such as misalignment and imbalance of a shaft. Some users may desire diagnosis for a frequency band to which the user desires to pay attention, rather than a specific frequency component produced by the anomaly of the bearing.

Therefore, an object of the present invention is to intelligibly show a result of vibration analysis in a vibration analysis apparatus that receives measurement data from a measurement instrument that measures vibration of a rotating body subjected to measurement and conducts vibration analysis.

Another object of the present invention is to be able to provide a result of diagnosis for a frequency band to which a user desires to pay attention in a vibration analysis apparatus that receives measurement data from a measurement instrument that measures vibration of a rotating body subjected to measurement and conducts vibration analysis.

In the diagnosis system described in PTL 1, the server conducts diagnosis, and hence data should be transferred between the information terminal and the server. Therefore, a network environment should be developed. Depending on a communication status, it may take time to transfer data, and it may take time to show the result of diagnosis on the information terminal.

Then, instead of the server, the information terminal may conduct diagnosis. In order for the information terminal to conduct diagnosis, specification data of a measurement target or coefficient data (specifically, a coefficient of a rotation frequency of a measurement target for calculating a damage frequency representing a frequency of vibration periodically produced in accordance with a damaged part of the measurement target, the coefficient corresponding to the damage frequency when the rotation frequency of the measurement target is a unit frequency) calculated based on the specification data in accordance with a prescribed arithmetic expression should be held in the information terminal. In this case, specifications of the measurement target are accumulation of know-how of a manufacturer, and sufficient attention should be paid to prevention of leakage of the specification data and the coefficient data calculated based on the specification data.

Therefore, another object of the present invention is to prevent, in a vibration analysis apparatus that receives measurement data from a measurement instrument that measures vibration of a rotating body subjected to measurement and conducts vibration analysis, leakage of specification data of the measurement target and coefficient data calculated based on the specification data.

### Solution to Problem

A vibration analysis apparatus according to one aspect of the present invention is a vibration analysis apparatus that receives measurement data from a measurement instrument and conducts vibration analysis that measures vibration of a rotating body subjected to measurement. The vibration analysis apparatus includes a setting unit, an analyzer, a processor, a determination unit, and a display. The setting unit sets information on the rotating body and a criterion value for diagnosing a vibration state of the rotating body. The analyzer conducts frequency analysis of the measurement data received from the measurement instrument. The processor specifies, for a prescribed number of peaks largest in peak value in the descending order in a frequency spectrum obtained by the frequency analysis, a part based on the information on the rotating body. The determination unit determines, for the prescribed number of peaks, the vibration state based on the peak value and the criterion value. The display shows, for the prescribed number of peaks, the peak value, the part, and a result of determination by the determination unit.

In this vibration analysis apparatus, for a prescribed number of peaks largest in peak value in the descending order in a frequency spectrum obtained by frequency analysis, a peak value, a part, and a result of determination by the determination unit are shown. Thus, a user does not have to search a shown result for a point to which attention should be paid or to read a value from a graph of the frequency spectrum, and the user can readily know, for a peak large in vibration, magnitude of vibration, the part, and a vibration state (for example, a danger level, a caution level, or a good level) of the part.

Preferably, the prescribed number is set by a user who uses the vibration analysis apparatus.

A vibration analysis apparatus according to another aspect of the present invention is a vibration analysis apparatus that receives measurement data from a measurement instrument that measures vibration of a rotating body subjected to measurement and conducts vibration analysis. The vibration analysis apparatus includes a setting unit, an analyzer, and a determination unit. The setting unit sets information on the rotating body, a plurality of frequency bands for which vibration analysis is conducted, and a plurality of criterion values provided in correspondence with the plurality of frequency bands, respectively. The analyzer conducts frequency analysis of the measurement data received from the measurement instrument. The determination unit determines, in each frequency band of the plurality of frequency bands, a vibration state in the frequency band based on a peak value of a frequency spectrum obtained by frequency analysis and a criterion value corresponding to the frequency band.

In this vibration analysis apparatus, a criterion value for diagnosing the vibration state is set for each frequency band, and in each frequency band, the vibration state in the frequency band is determined based on the peak value of the frequency spectrum and the criterion value corresponding to the frequency band. Thus, diagnosis is conducted based not on a specific frequency component caused by an abnormal condition (a fault of an inner ring, an outer ring, a rolling element, or a cage) of the bearing but on an appropriate criterion value for each set frequency band. Therefore, this vibration analysis apparatus can provide a result of diagnosis for a frequency band to which a user desires to pay attention.

Preferably, the plurality of frequency bands are set by a user who uses the vibration analysis apparatus.

A vibration analysis apparatus according to another aspect of the present invention is a vibration analysis apparatus that receives measurement data from a measurement instrument that measures vibration of a rotating body subjected to measurement and conducts vibration analysis. The vibration analysis apparatus includes a database unit and a processor. In the database unit, a coefficient of a rotation frequency of the rotating body for calculating a damage frequency representing a frequency of vibration periodically produced in accordance with a damaged part of the rotating body is stored as being divided into a plurality of constants. In vibration analysis, the processor reads the plurality of constants from the database unit to restore the coefficient of the rotation frequency and calculates the damage frequency from the restored coefficient.

The coefficient of the rotation frequency of the rotating body for calculating the damage frequency of the rotating body includes information on specifications of the rotating body. In this vibration analysis apparatus, the coefficient is stored in the database unit as being divided into a plurality of constants. Then, in vibration analysis, the plurality of constants are read from the database unit to restore the coefficient of the rotation frequency, and the damage frequency is calculated from the restored coefficient. Thus, the specification of the rotating body can be prevented from being elucidated in the event of leakage of data stored in the database unit to the outside. Therefore, the vibration analysis apparatus can prevent leakage of specification data of the rotating body subjected to measurement.

Preferably, in the database unit, encrypted data resulting from encryption of the plurality of constants is stored. The processor reads the encrypted data from the database unit to decrypt the encrypted data and restores the coefficient from the plurality of constants that have been decrypted.

Preferably, in the database unit, the plurality of constants are stored in a binary format.

A vibration analysis apparatus according to another aspect of the present invention is a vibration analysis apparatus that receives measurement data from a measurement instrument that measures vibration of a rotating body subjected to measurement and conducts vibration analysis. The vibration analysis apparatus includes a database unit and a processor. In the database unit, encrypted data resulting from encryption of specification data of the rotating body is stored. In vibration analysis, the processor reads the encrypted data from the database unit to decrypt the encrypted data, and calculates a damage frequency representing a frequency of vibration periodically produced in accordance with a damaged part of the rotating body based on the specification data that has been decrypted.

In this vibration analysis apparatus, the specification data of the rotating body used for calculating the damage frequency is stored in the database unit as being encrypted. Then, in vibration analysis, the encrypted data is read from the database unit and decrypted, and based on the decrypted specification data, the damage frequency representing the frequency of vibration periodically produced in accordance with the damaged part of the rotating body is calculated. Thus, the specification of the rotating body can be prevented from being elucidated in the event of leakage of data stored in the database unit to the outside. Therefore, the vibration analysis apparatus can prevent leakage of specification data of the rotating body subjected to measurement.

Preferably, the encrypted data resulting from encryption of the specification data in a binary format is stored in the database unit.

Preferably, the rotating body is a bearing.

Preferably, the information on the rotating body includes (i) a rotation speed or a rotation frequency of the bearing and (ii) a specification of the bearing or a coefficient of the rotation frequency used for calculation of a ball pass frequency of inner ring (BPFI), a ball pass frequency of outer ring (BPFO), and a ball spin frequency (BSF) of the bearing.

Preferably, the vibration analysis apparatus further includes a communication unit that wirelessly communicates with the measurement instrument.

A vibration measurement system according to the present invention includes a measurement instrument that measures vibration of a rotating body subjected to measurement and the above-described vibration analysis apparatus that receives measurement data from the measurement instrument and conducts vibration analysis.

### Advantageous Effects of Invention

According to the present invention, the vibration analysis apparatus that receives measurement data from the measurement instrument that measures vibration of the rotating body subjected to measurement and conducts vibration analysis can intelligibly show a result of vibration analysis.

According to the present invention, the vibration analysis apparatus that receives measurement data from the measurement instrument that measures vibration of the rotating body subjected to measurement and conducts vibration analysis can provide a result of diagnosis for a frequency band to which a user desires to pay attention.

According to the present invention, the vibration analysis apparatus that receives measurement data from the measurement instrument that measures vibration of the rotating body subjected to measurement and conducts vibration analysis can prevent leakage of specification data of a measurement target.

### BRIEF DESCRIPTION OF DRAWINGS

FIG. 1 is a diagram showing a vibration measurement system according to a first embodiment of the present invention.

FIG. 2 is a diagram showing a configuration of a measurement instrument.

FIG. 3 is a diagram showing a configuration of a portable information terminal.

FIG. 4 is a diagram showing exemplary representation by a display.

FIG. 5 is a diagram showing exemplary information set by a setting unit.

FIG. 6 is a flowchart showing an exemplary procedure in processing in the measurement instrument.

FIG. 7 is a flowchart showing an exemplary procedure in processing in the portable information terminal.

FIG. 8 is a diagram showing an exemplary criterion value in a second embodiment.

FIG. 9 is a diagram showing exemplary information set by the setting unit in the second embodiment.

FIG. 10 is a flowchart showing an exemplary procedure in processing in the portable information terminal in the second embodiment.

FIG. 11 is a diagram showing exemplary information set by the setting unit in a third embodiment.

FIG. 12 is a diagram showing exemplary data stored in a database unit in the third embodiment.

FIG. 13 is a flowchart showing an exemplary procedure in processing in the portable information terminal in the third embodiment.

FIG. 14 is a diagram showing an exemplary configuration of the portable information terminal in a fourth embodiment.

FIG. 15 is a flowchart showing an exemplary procedure in processing in the portable information terminal in the fourth embodiment.

FIG. 16 is a diagram showing another configuration of the vibration measurement system.

### DESCRIPTION OF EMBODIMENTS

An embodiment of the present invention will be described in detail below with reference to the drawings. Though a plurality of embodiments will be described below, combination as appropriate of features described in the embodiments is originally intended. The same or corresponding elements in the drawings have the same reference characters allotted and description thereof will not be repeated.

### First Embodiment

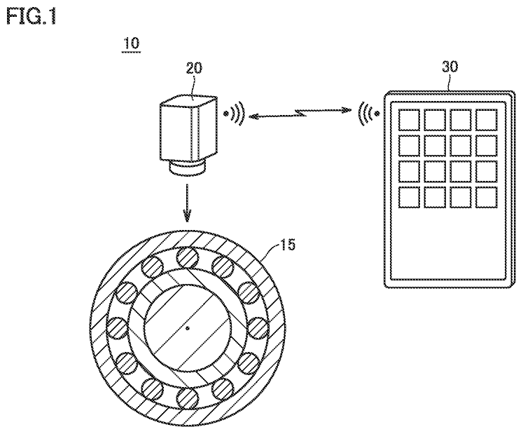

FIG. 1 is a diagram showing a vibration measurement system according to a first embodiment of the present invention. Referring to FIG. 1, a vibration measurement system 10 includes a measurement instrument 20 and a portable information terminal 30.

Measurement instrument 20 is an instrument that measures vibration produced in a rolling bearing 15 subjected to measurement and includes an acceleration sensor (not shown) that detects vibration. Measurement instrument 20 is configured to wirelessly communicate with portable information terminal 30. When measurement instrument 20 receives a measurement start signal from portable information terminal 30, it detects vibration produced in rolling bearing 15 with the acceleration sensor. Then, measurement instrument 20 transmits acceleration data obtained by detection by the acceleration sensor to portable information terminal 30.

Portable information terminal 30 corresponds to the “vibration analysis apparatus” in the present invention, and it receives measurement data (acceleration data of vibration) from measurement instrument 20 and analyzes vibration produced in rolling bearing 15. Portable information terminal 30 is a terminal that can be used by a user who uses vibration measurement system 10, and examples thereof include a smartphone and a tablet. With application software that runs on portable information terminal 30, portable information terminal 30 can be used as the “vibration analysis apparatus.”

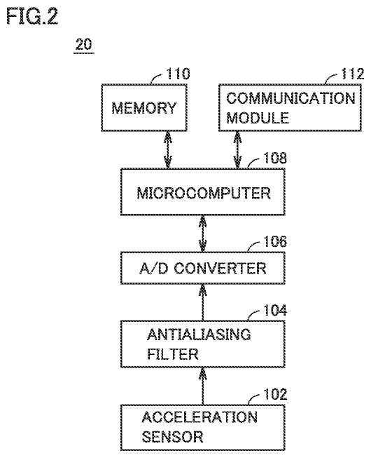

FIG. 2 is a diagram showing a configuration of measurement instrument 20. Referring to FIG. 2, measurement instrument 20 includes an acceleration sensor 102, an antialiasing filter 104, an A/D converter 106, a microcomputer 108, a memory 110, and a communication module 112.

Acceleration sensor 102 is attached to a housing in which rolling bearing 15 (FIG. 1) subjected to measurement is contained, and it detects, and provides output of, an acceleration of vibration produced in rolling bearing 15. Antialiasing filter 104 is a low-pass filter that suppresses aliasing produced in A/D conversion in A/D converter 106. A/D converter 106 converts a measurement signal (an analog signal) that has passed through antialiasing filter 104 to a digital signal.

Microcomputer 108 receives acceleration data converted to the digital signal by A/D converter 106 and provides the acceleration data to memory 110. Then, as a prescribed amount of data is accumulated in memory 110, microcomputer 108 reads accumulated data from memory 110 and communication module 112 transmits the data to portable information terminal 30 as measurement data obtained by measurement instrument 20.

Memory 110 receives acceleration data converted to the digital signal by A/D converter 106 from microcomputer 108, and the acceleration data is temporarily stored in memory 110. Communication module 112 is a wireless module for measurement instrument 20 to wirelessly communicate with portable information terminal 30.

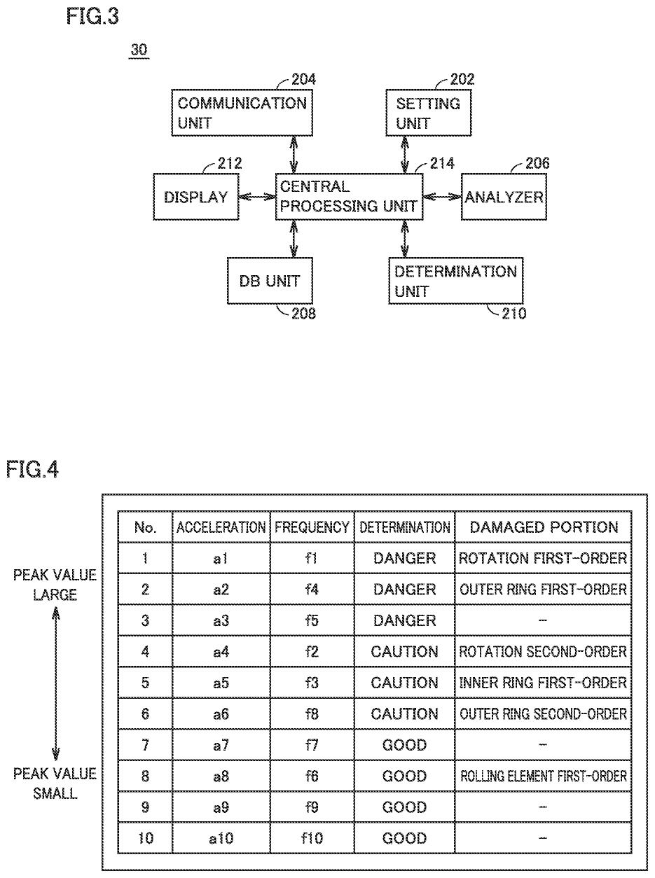

FIG. 3 is a diagram showing a configuration of portable information terminal 30. Referring to FIG. 3, portable information terminal 30 includes a setting unit 202, a communication unit 204, an analyzer 206, a database (DB) unit 208, a determination unit 210, a display 212, and a central processing unit 214.

Setting unit 202 sets information on rolling bearing 15 (FIG. 1) subjected to measurement. Though the set information is entered by a user on a screen of portable information terminal 30 in the present first embodiment, it may be stored in advance in DB unit 208 and read from DB unit 208 at the time of start of measurement of vibration by vibration measurement system 10. Information on rolling bearing 15 includes a bearing model number of rolling bearing 15 and a rotation speed or a rotation frequency of rolling bearing 15 in measurement by measurement instrument 20.

In the present first embodiment, specification data of various bearings that can be subjected to vibration measurement by vibration measurement system 10 is stored in advance in DB unit 208 as being associated with the bearing model numbers. Then, the specification data of the bearing having the bearing model number set by setting unit 202 is read from DB unit 208. Setting unit 202, however, may directly set the specification data of rolling bearing 15 as information on rolling bearing 15.

Setting unit 202 further sets a criterion value for determination by determination unit 210, of a vibration state of rolling bearing 15 subjected to measurement. Though this criterion value is also entered by the user on the screen of portable information terminal 30 in the present first embodiment, it may be stored in advance in DB unit 208 and may be read from DB unit 208 at the time of start of vibration measurement by vibration measurement system 10.

Communication unit 204 is a unit for portable information terminal 30 to establish wireless communication with measurement instrument 20, and it is implemented by a wireless module. Communication unit 204 transmits a measurement start signal to measurement instrument 20 at the time of start of vibration measurement by vibration measurement system 10 in response to an instruction from central processing unit 214. Communication unit 204 receives measurement data (acceleration data) transmitted from measurement instrument 20.

Analyzer 206 conducts frequency analysis of measurement data (acceleration data) received by communication unit 204. By way of example, analyzer 206 performs fast Fourier transform (FFT) processing on time-series acceleration data received by communication unit 204 and generates a frequency spectrum of the measurement data (acceleration data).

Specification data of various bearings that can be subjected to vibration measurement by this vibration measurement system 10 is stored in DB unit 208 as being associated with the bearing model numbers. In the present first embodiment, the specification data includes at least data from which the ball pass frequency of inner ring (BPFI), the ball pass frequency of outer ring (BPFO), and the ball spin frequency (BSF) shown in expressions (1) to (3) below can be calculated.

$$\begin{matrix}[ Expression 1 ] & \\ BPFI = \frac{Z}{2} {f}_{0} ( 1 + \frac{d}{D} cos α ) & ( 1 )\end{matrix}$$

$$BPFO = \frac{Z}{2} {f}_{0} ( 1 - \frac{d}{D} cos α ) \qquad ( 2 )$$

$$BSF = {f}_{0} \frac{D}{2 d} \{ 1 - {( \frac{d}{D} )}^{2} {cos}^{2} α \} \qquad ( 3 )$$

D represents a diameter of a pitch circle of the bearing, d represents a diameter of the rolling element, a represents a contact angle of the rolling element, and Z represents the number of rolling elements. f0 represents a rotation frequency of an inner ring shaft and is set by setting unit 202. Alternatively, when setting unit 202 sets the rotation speed, f0 is calculated from the rotation speed.

At least the specification data including diameter D of the pitch circle, diameter d of the rolling element, contact angle α of the rolling element, and the number Z of rolling elements is stored in DB unit 208 as being associated with the bearing model number. Instead of the specification data, coefficients Cin, Cout, and Crol of rotation frequency f0 for calculating the BPFI, the BPFO, and the BSF may be stored in DB unit 208. Coefficients Cin, Cout, and Crol are shown in expressions (4) to (6) below.

$$\begin{matrix}[ Expression 2 ] & \\ {C}_{in} = \frac{Z}{2} ( 1 + \frac{d}{D} cos α ) & ( 4 )\end{matrix}$$

$${C}_{o ut} = \frac{Z}{2} ( 1 - \frac{d}{D} cos α ) \qquad ( 5 )$$

$${C}_{rol} = \frac{D}{2 d} \{ 1 - {( \frac{d}{D} )}^{2} {cos}^{2} α \} \qquad ( 6 )$$

Central processing unit 214 calculates the BPFI, the BPFO, and the BSF of rolling bearing 15 in measurement based on the information on rolling bearing 15 set by setting unit 202. Specifically, central processing unit 214 reads the specification data of the bearing corresponding to the bearing model number set by setting unit 202 from DB unit 208 and calculates the BPFI, the BPFO, and the BSF in accordance with the expressions (1) to (3) based on the read specification data and the rotation speed (or the rotation frequency) set by setting unit 202.

In addition, for peaks in a frequency spectrum of the acceleration data obtained by analyzer 206, central processing unit 214 specifies a part for each peak. More specifically, a peak having a frequency (which is referred to as a “peak frequency” below) that matches with the BPFI and a higher-order component thereof is specified as indicating a fault of the inner ring. A peak having a peak frequency that matches with the BPFO and a higher-order component thereof is specified as indicating a fault of the outer ring, and a peak having a peak frequency that matches with the BSF and a higher-order component thereof is specified as indicating a fault of the rolling element.

A peak having a peak frequency that matches with the rotation frequency of the shaft and a higher-order component thereof is specified as indicating imbalance in the shaft, and a peak having a peak frequency that matches with a frequency twice as high as the rotation frequency and a higher-order component thereof is specified as indicating misalignment. Thus, in the present first embodiment, for a part corresponding to the peak, not only parts of the bearing (the inner ring, the outer ring, and the rolling element) corresponding to the BPFI, the BPFO, and the BSF but also a part other than the bearing itself such as imbalance of the shaft or misalignment is specified.

Determination unit 210 determines the vibration state for each peak based on the peak value (acceleration) of the peak frequency and the criterion value set by setting unit 202. For example, determination unit 210 determines a peak having a peak value exceeding the criterion value as “danger”. Determination unit 210 determines a peak having a peak value smaller than the criterion value but exceeding eighty percent of the criterion value as “caution”, and determines a peak having a peak value smaller than eighty percent of the criterion value as “good”.

Display 212 shows, for peaks having top ten peak values, the peak value, the part, and the result of determination (“danger”, “caution”, “good”, and the like) by determination unit 210 on a screen of portable information terminal 30. The number of shown peaks is not limited to ten, but may be set to other numbers or may be set by a user on the screen of portable information terminal 30 with the default being ten.

In this first embodiment, in accordance with the number of peaks shown by display 212, central processing unit 214 specifies a part for the peaks having the top ten peak values, and determination unit 210 determines the vibration state for the peaks having the top ten peak values. Central processing unit 214, however, may specify the part for all specified peaks and determination unit 210 may determine the vibration state for all specified peaks.

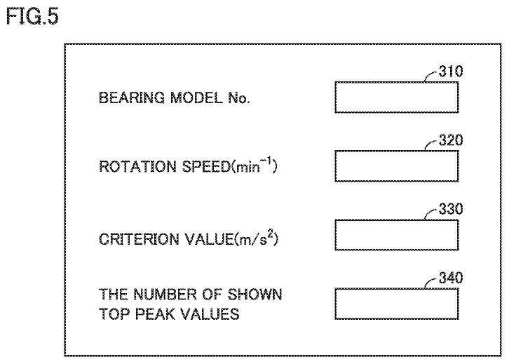

FIG. 4 is a diagram showing exemplary representation by display 212. FIG. 4 shows the screen of portable information terminal 30 on which representation information is shown by display 212.

Referring to FIG. 4, in this example, for peaks having top ten peak values, the peak value (acceleration), the peak frequency, the result of determination by determination unit 210, and the part (damaged portion) are shown in the descending order of magnitude of the peak values (acceleration) (a1>a2> . . . >a10). The shown peaks include also a peak of a higher-order component (“rotation second-order,” “outer ring second-order,” and the like).

Though representation is given in the descending order of magnitude of the peak values in the present example, representation may be given in the ascending order of magnitude of the frequency (f1<f2< . . . <f10). Depending on results of determination, a color used for representation may be different (for example, “danger” shown with red, “caution” shown with yellow, and “good” shown with green).

FIG. 5 is a diagram showing exemplary information set by setting unit 202. Information set by setting unit 202 can be entered by a user on the screen of portable information terminal 30, and FIG. 5 shows the screen of portable information terminal 30 for entry of information by the user.

Referring to FIG. 5, the bearing model number of rolling bearing 15 (FIG. 1) subjected to measurement can be entered in an input section 310.

A rotation speed (min⁻¹) of the shaft in measurement can be entered in an input section 320. Since vibration measurement system 10 is not provided with a sensor that detects the rotation speed of the shaft in measurement by measurement instrument 20, information on the rotation speed should be obtained and entered in input section 320 in measurement. When a rotation speed sensor is annexed, however, input section 320 does not have to be provided. The rotation frequency of the shaft in measurement instead of the rotation speed of the shaft in measurement may be entered in input section 320.

A criterion value (acceleration) to be used by determination unit 210 can be entered in an input section 330. In the present first embodiment, the criterion value is set to a uniform value regardless of the peak frequency.

The number of peaks having largest peak values to be shown by display 212 can be entered in an input section 340. The number of peaks to be shown by display 212 is set in accordance with this input value. When there is no entry into input section 340, a default value (for example, ten) is set.

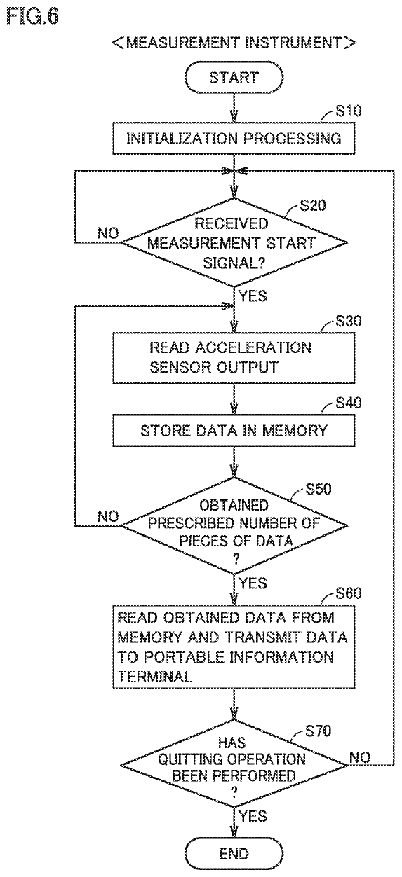

FIG. 6 is a flowchart showing an exemplary procedure in processing in measurement instrument 20. Referring to FIG. 2 together with FIG. 6, when power of measurement instrument 20 is turned on, microcomputer 108 performs prescribed initialization processing (step S10). In the initialization processing, for example, communication between communication module 112 and portable information terminal 30 is established and data in memory 110 is cleared.

Then, microcomputer 108 determines whether or not it has received a measurement start signal from portable information terminal 30 (step S20). Then, when microcomputer 108 has received the measurement start signal (YES in step S20), it reads from A/D converter 106, an output from acceleration sensor 102 that has passed through antialiasing filter 104 and digitally converted by A/D converter 106 (step S30).

Microcomputer 108 has data read from A/D converter 106 temporarily stored in memory 110 (step S40). Then, microcomputer 108 determines whether or not the number of pieces of obtained data has reached a prescribed number (step S50). When the number of pieces of obtained data has not reached the prescribed number (NO in step S50), microcomputer 108 repeats processing in steps S30 and S40.

When microcomputer 108 determines in step S50 that the number of pieces of obtained data has reached the prescribed number (YES in step S50), microcomputer 108 reads obtained data from memory 110 and transmits the data to portable information terminal 30 by means of communication module 112 (step S60).

Then, microcomputer 108 determines whether or not the user has performed a quitting operation to quit measurement (step S70). The quitting operation is performed onto portable information terminal 30, and when the microcomputer receives a measurement quitting signal from portable information terminal 30, it determines that the quitting operation has been performed.

When the microcomputer determines that the quitting operation has not been performed (NO in step S70), the process returns to step S20. When the microcomputer determines that the quitting operation has been performed (YES in step S70), the process proceeds to end and a series of processing in measurement instrument 20 ends.

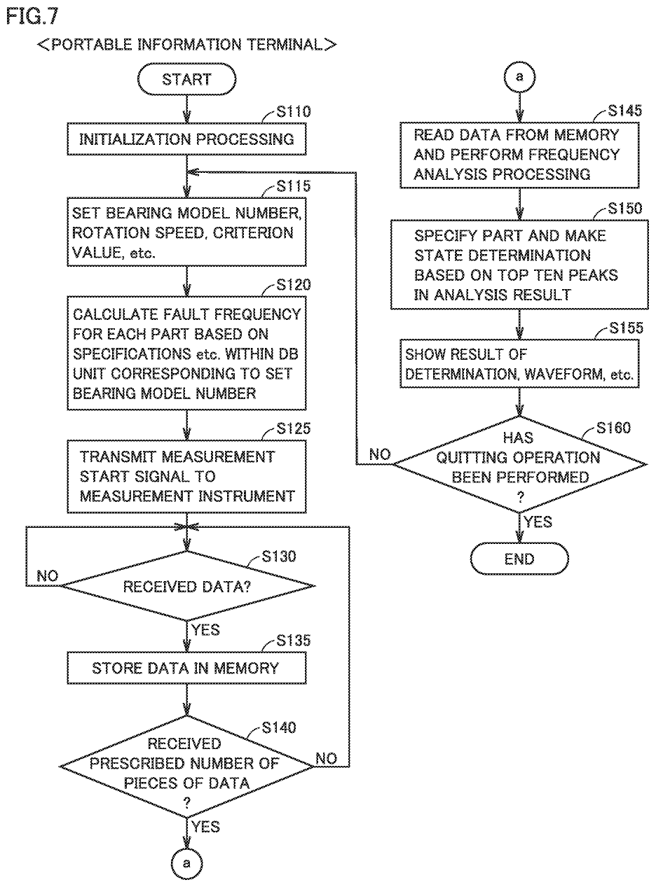

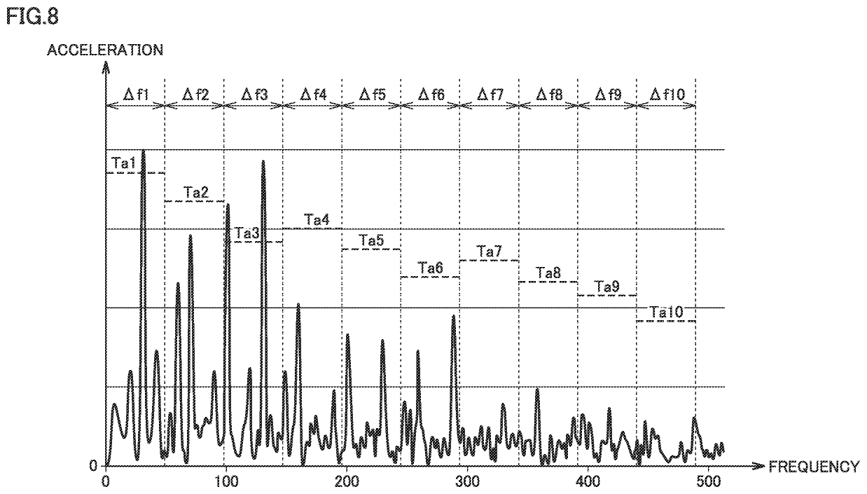

FIG. 7 is a flowchart showing an exemplary procedure in processing in portable information terminal 30. Referring to FIG. 3 together with FIG. 7, when application software for vibration measurement with the use of measurement instrument 20 is launched on portable information terminal 30 and start of measurement is indicated by means of the application software, central processing unit 214 performs prescribed initialization processing (step S110). In the initialization processing, for example, communication between communication unit 204 and measurement instrument 20 is established and prescribed resetting processing is performed.

Then, in response to an instruction from central processing unit 214, setting unit 202 sets the bearing model number of rolling bearing 15 subjected to measurement, the rotation speed (or the rotation frequency) in measurement, the criterion value for determining the vibration state based on measurement data, and the like (step S115). Each set value is entered by a user on the screen of portable information terminal 30.

Then, central processing unit 214 reads specification data of the bearing corresponding to the set bearing model number from DB unit 208 and calculates the BPFI, the BPFO, and the BSF of rolling bearing 15 subjected to measurement in accordance with the expressions (1) to (3) based on the specification data and the rotation frequency calculated from the set rotation speed (step S120). Thereafter, central processing unit 214 transmits the measurement start signal to measurement instrument 20 through communication unit 204 (step S125).

When the measurement start signal is transmitted to measurement instrument 20, central processing unit 214 determines whether or not it has received measurement data (acceleration data) from measurement instrument 20 (step S130). Then, when central processing unit 214 has received the measurement data from measurement instrument 20 (YES in step S130), it has the received measurement data stored in the memory (not shown) (step S135).

Then, central processing unit 214 determines whether or not the number of pieces of measurement data received from measurement instrument 20 has reached a prescribed number (step S140). When the number of pieces of data has not reached the prescribed number (NO in step S140), the central processing unit repeats processing in steps S130 and S135.

When central processing unit 214 determines in step S140 that the number of pieces of data has reached the prescribed number (YES in step S140), it reads data from the memory and has analyzer 206 conduct frequency analysis of data (acceleration data) resulting from measurement by measurement instrument 20 (step S145). Specifically, fast Fourier transform (FFT) processing is performed on time-series acceleration data obtained by measurement by measurement instrument 20 to obtain a frequency spectrum of the obtained acceleration data.

Then, for peaks in the obtained frequency spectrum, central processing unit 214 extracts top ten peak values and specifies a part corresponding to the peak frequency for the extracted top ten peaks. Specifically, central processing unit 214 specifies for each of the extracted peaks, from which of a fault of the inner ring, a fault of the outer ring, a fault of the rolling element, imbalance of the shaft, and misalignment the peak is derived based on whether or not the peak frequency matches with any of the BPFI, the BPFO, the BSF, and a higher-order component thereof or whether or not it matches with any of the rotation frequency of the shaft, the frequency twice as high as that, and a higher-order component thereof. Then, for each specified part, central processing unit 214 has determination unit 210 determine the vibration state of each part based on the set criterion value (step S150).

For example, determination unit 210 determines a peak having the peak value exceeding the criterion value as “danger”. Determination unit 210 determines a peak having the peak value smaller than the criterion value but exceeding eighty percent of the criterion value as “caution” and determines a peak having the peak value smaller than eighty percent of the criterion value as “good”.

Then, for each of the peaks having the top ten peak values, central processing unit 214 has display 212 show the result of determination in step S150, the peak value, the peak frequency, and the part on the screen of portable information terminal 30 together with a waveform of the frequency spectrum (step S155).

Then, central processing unit 214 determines whether or not the user has performed the quitting operation to quit measurement (step S160). When the central processing unit determines that the quitting operation has not been performed (NO in step S160), the process returns to step S115. When the central processing unit determines that the quitting operation has been performed (YES in step S160), the process proceeds to end and a series of processing in portable information terminal 30 ends.

As set forth above, in this first embodiment, for the peaks having the top ten peak values in the frequency spectrum of measurement data, the peak value (acceleration), the peak frequency, the result of determination of the vibration state (“danger”, “caution”, “good”, and the like), and the part (damaged portion) are shown on the screen of portable information terminal 30. The user can thus readily know, for a peak large in vibration, magnitude thereof, the part, and the vibration state of the part.

According to this first embodiment, the user can set the number of peaks to be shown, and hence representation as desired by the user can be realized. Since measurement instrument 20 and portable information terminal 30 wirelessly communicate with each other, the user can check a result of vibration analysis at any location within an area where wireless communication can be established, simply by installing measurement instrument 20 in a measurement target.

### Second Embodiment

In the first embodiment, the criterion value for determining the vibration state (“danger”, “caution”, “good”, and the like) is uniformly set regardless of a frequency. In this second embodiment, the criterion value is set for each frequency band. Thus, diagnosis is conducted based on an appropriate criterion value for each set frequency band, and diagnosis for the frequency band to which a user desires to pay attention can be provided.

An overall configuration of the vibration measurement system according to this second embodiment is similar to that in the first embodiment shown in FIGS. 1 to 3.

FIG. 8 is a diagram showing an exemplary criterion value in the second embodiment. In FIG. 8, the abscissa represents a frequency and the ordinate represents an acceleration (vibration). Referring to FIG. 8, a waveform represents an exemplary result of frequency analysis conducted by analyzer 206.

A criterion value Tai (i=1 to 10) is set for each frequency band Δfi (i=1 to 10). In this example, ten frequency bands equal in width are set from a frequency 0, and the criterion value is set for each frequency band. The number of frequency bands, however, is not limited to ten, and the width of each frequency band does not necessarily have to be equal either.

In determining frequency band Δfi, for example, the width and the number of frequency bands may be set with the width of each frequency band being set to be equal, or an upper limit of a frequency to be analyzed may be set with the number of frequency bands being set to a certain number.

Then, by setting the criterion value for each set frequency band, for a frequency band to which a user desires to pay attention, an appropriate result of diagnosis can be provided to the user.

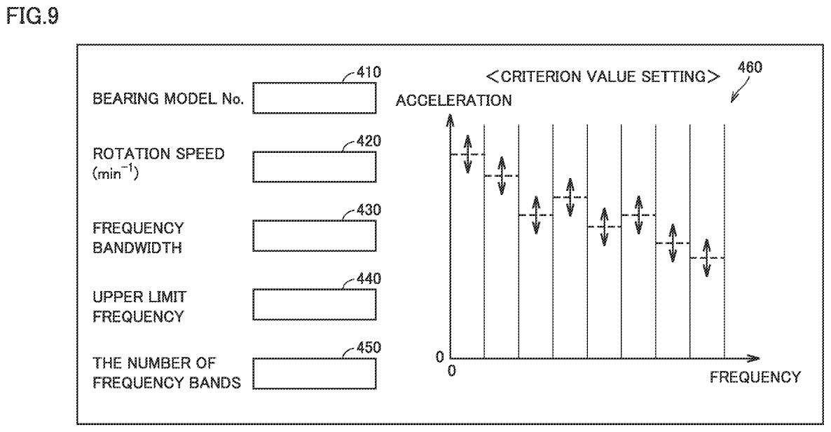

FIG. 9 is a diagram showing exemplary information set by setting unit 202 in the second embodiment. In the second embodiment as well, the user can enter the information set by setting unit 202 on the screen of portable information terminal 30, and FIG. 9 shows the screen of portable information terminal 30 for entry of information by the user.

Referring to FIG. 9, in an input section 410, the bearing model number of rolling bearing 15 (FIG. 1) subjected to measurement can be entered. In an input section 420, a rotation speed (min⁻¹) of the shaft in measurement can be entered. The rotation frequency of the shaft in measurement instead of the rotation speed of the shaft in measurement may be entered in input section 420.

In an input section 430, for determination as to the vibration state to be made based on the criterion value set for each frequency band, in setting an equal width of the frequency band, that width of the frequency band can be entered. In an input section 440, in setting the certain number of frequency bands, the upper limit of the frequency to be analyzed can be entered. The user should only provide entry into any one of input sections 430 and 440. If entry is provided into both of input sections 430 and 440, a value in predetermined one of them (for example, input section 430) is adopted.

In an input section 450, the number of frequency bands can be entered. When a frequency bandwidth has been set by entry into input section 430, frequency band(s) having the frequency bandwidth as many as the number entered into input section 450 is (are) set. When the upper limit frequency has been set by entry into input section 440, by dividing the upper limit frequency by the number entered into input section 450, the frequency band(s) as many as the number entered into input section 450 is (are) set.

In an input section 460, the criterion value can be set for each frequency band. In input section 460, each frequency band set based on the frequency bandwidth entered in input section 430 or the upper limit frequency entered in input section 440 and on the number of frequency bands entered in input section 450 is shown, and the criterion value is shown for each frequency band. The criterion value shown in input section 460 can be moved up and down by using an input device (a mouse, a touch panel, or the like). The user can set in input section 460, the criterion value for each frequency band by using the input device.

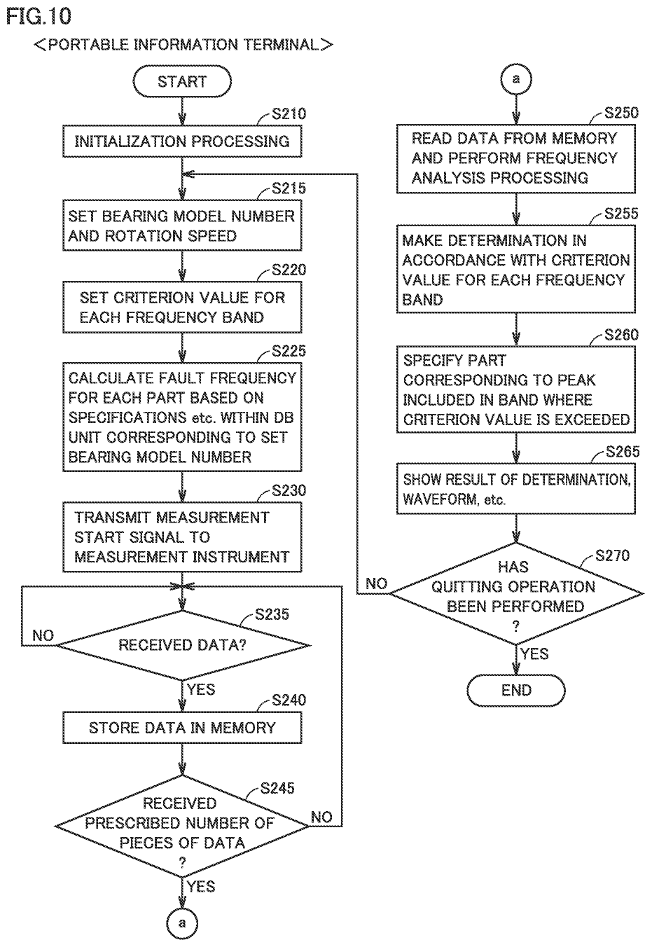

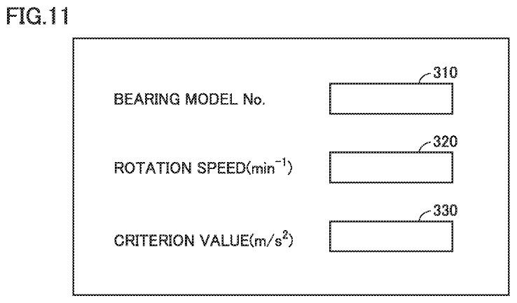

FIG. 10 is a flowchart showing an exemplary procedure in processing in portable information terminal 30 in the second embodiment. Referring to FIG. 3 together with FIG. 10, in the second embodiment as well, when application software for vibration measurement with the use of measurement instrument 20 is launched on portable information terminal 30 and start of measurement is indicated by means of the application software, central processing unit 214 performs prescribed initialization processing (step S210). This initialization processing is the same as the processing performed in step S110 in FIG. 7.

Then, in response to an instruction from central processing unit 214, setting unit 202 sets the bearing model number of rolling bearing 15 subjected to measurement, the rotation speed (or the rotation frequency) in measurement, and the like (step S215). Each set value is entered by a user on the screen of portable information terminal 30.

Furthermore, setting unit 202 sets the criterion value for each frequency band (step S220). As described with reference to FIG. 9, each frequency band is set based on input values in input sections 430 and 450, and the criterion value for each frequency band is set based on entry into input section 460.

When the criterion value is set for each frequency band in step S220, the process proceeds to step S225. Since processing in steps S225 to S250 is the same as the processing in steps S120 to S145 in FIG. 7, description will not be repeated.

When frequency analysis of data (acceleration data) obtained by measurement by measurement instrument 20 is conducted in step S250, central processing unit 214 has determination unit 210 determine the vibration state of rolling bearing 15 for each frequency band based on the criterion value for each frequency band set in step S220 (step S255).

For example, when there is a peak having the peak value exceeding the criterion value for each frequency band, determination as “danger” is made. When there is a peak having the peak value exceeding eighty percent of the criterion value although there is no peak having the peak value exceeding the criterion value, determination as “caution” is made, and when there is no peak having the peak value exceeding eighty percent of the criterion value, determination as “good” is made.

Then, for the peak having the peak value exceeding the criterion value, central processing unit 214 specifies a part corresponding to the peak (step S260). Specifically, central processing unit 214 specifies, for each peak having the peak value exceeding the criterion value, from which of a fault of the inner ring, a fault of the outer ring, a fault of the rolling element, imbalance of the shaft, and misalignment the peak is derived based on whether or not the peak frequency matches with any of the BPFI, the BPFO, the BSF, and a higher-order component thereof or whether or not it matches with any of the rotation frequency of the shaft, the frequency twice as high as that, and a higher-order component thereof.

Then, for each peak having the peak value exceeding the criterion value, central processing unit 214 has display 212 show the result of determination in step S255, the peak value, the peak frequency, and the part on the screen of portable information terminal 30, together with a waveform of the frequency spectrum (step S265).

Then, central processing unit 214 determines whether or not the user has performed the quitting operation to quit measurement (step S270). When the central processing unit determines that the quitting operation has not been performed (NO in step S270), the process returns to step S215. When the central processing unit determines that the quitting operation has been performed (YES in step S270), the process proceeds to end and a series of processing in portable information terminal 30 ends.

As set forth above, in this second embodiment, the criterion value is set for each frequency band, and in each frequency band, the vibration state is determined based on the peak value of the frequency spectrum and the criterion value. Thus, diagnosis is conducted based not on a specific frequency component produced by an abnormal condition (a fault of the inner ring, the outer ring, the rolling element, or the cage) of the bearing, but on an appropriate criterion value for each set frequency band. Therefore, according to this second embodiment, a result of diagnosis for a frequency band to which a user desires to pay attention can be provided.

Since measurement instrument 20 and portable information terminal 30 wirelessly communicate with each other also in this second embodiment, the user can check a result of vibration analysis at any location within an area where wireless communication can be established simply by installing measurement instrument 20 in a measurement target.

### Third Embodiment

An overall configuration of the vibration measurement system according to a third embodiment is similar to that in the first embodiment shown in FIGS. 1 to 3.

In the third embodiment, for various bearings that can be subjected to vibration measurement by vibration measurement system 10, data on a coefficient of a rotation frequency (a plurality of constants obtained by dividing the coefficient) of the bearing for calculating a damage frequency for specifying a damaged part of the bearing in accordance with a prescribed arithmetic expression based on specification data of the bearing is stored in DB unit 208 as being associated with a bearing model number. Then, the data corresponding to the bearing model number set by setting unit 202 is read from DB unit 208, the damage frequency is calculated based on the read data, and the damaged part is specified.

Referring again to FIG. 3, in the present third embodiment, data on the coefficient of the rotation frequency of the shaft for calculation of a ball pass frequency of inner ring (BPFI), a ball pass frequency of outer ring (BPFO), and a ball spin frequency (BSF) of rolling bearing 15 subjected to measurement is stored in DB unit 208 as being associated with the bearing model number.

Specifically, in this third embodiment, the server is not used but portable information terminal 30 specifies a damaged part. Therefore, the coefficient of the rotation frequency of the bearing for calculating the BPFI, the BPFO, and the BSF of rolling bearing 15 subjected to measurement should be held in portable information terminal 30.

The BPFI, the BPFO, and the BSF of rolling bearing 15 can be calculated in accordance with expressions (7) to (9) below, based on various specifications of rolling bearing 15 and rotation frequency f0 of an inner ring shaft of the bearing in measurement.

$$\begin{matrix}[ Expression 3 ] & \\ BPFI = \frac{Z}{2} {f}_{0} ( 1 + \frac{d}{D} cos α ) = {C}_{i n} \times {f}_{0} & ( 7 )\end{matrix}$$

$$BPFO = \frac{Z}{2} {f}_{0} ( 1 - \frac{d}{D} cos α ) = {C}_{o u t} \times {f}_{0} \qquad ( 8 )$$

$$BSF = {f}_{0} \frac{D}{2 d} \{ 1 - {( \frac{d}{D} )}^{2} {cos}^{2} α \} = {C}_{rol} \times {f}_{0} \qquad ( 9 )$$

D represents a diameter of a pitch circle of the bearing, d represents a diameter of the rolling element, α represents a contact angle of the rolling element, Z represents the number of rolling elements, and each value corresponds to the specifications of rolling bearing 15.

Rotation frequency f0 corresponds to a measurement condition, and is set by setting unit 202. When setting unit 202 sets the rotation speed, rotation frequency f0 is calculated from the set rotation speed. Coefficients Cin, Cout, and Crol of rotation frequency f0 are calculated based on the specifications (diameter D of the pitch circle of the bearing, diameter d of the rolling element, contact angle α of the rolling element, and the number Z of rolling elements) of rolling bearing 15.

Thus, in order to calculate the BPFI, the BPFO, and the BSF in portable information terminal 30, the specification data (diameter D of the pitch circle of the bearing, diameter d of the rolling element, contact angle α of the rolling element, and the number Z of rolling elements) of rolling bearing 15 or coefficients Cin, Cout, and Crol calculated based on the specification data should be held in portable information terminal 30.

Specifications of a measurement target, however, are accumulation of know-how of a manufacturer. Therefore, sufficient attention should be paid to prevention of leakage of specification data or coefficients Cin, Cout, and Crol calculated based on the specification data.

Then, in vibration measurement system 10 according to the present third embodiment, each of coefficients Cin, Cout, and Crol is stored in DB unit 208 of portable information terminal 30 as being divided into a plurality of constants. For example, coefficients Cin, Cout, and Crol are stored in DB unit 208 as being divided into constants Ca to Cd shown in expressions (10) to (12) below.

[Expression 4]

Cᵢₙ=Cₐ+C_{b} (10)

Cₒᵤₜ=Cₐ−C_{b} (11)

Cᵣₒₗ=C_{c}−C_{d} (12)

Constants Ca to Cd are as below.

$$\begin{matrix}[ Expression 5 ] & \\ {C}_{a} = \frac{Z}{2} & ( 13 )\end{matrix}$$

$${C}_{b} = \frac{Z \times d \times cos α}{2 D} \qquad ( 14 )$$

$${C}_{c} = \frac{D}{2 d} \qquad ( 15 )$$

$${C}_{d} = \frac{d \times {cos}^{2} α}{2 D} \qquad ( 16 )$$

By thus storing coefficients Cin, Cout, and Crol calculated based on the specification data as being divided into the plurality of constants Ca to Cd in DB unit 208, elucidation of the specifications of rolling bearing 15 subjected to measurement in the event of leakage of data stored in DB unit 208 to the outside can be prevented.

In the present third embodiment, central processing unit 214 calculates the BPFI, the BPFO, and the BSF of rolling bearing 15 in measurement based on the information on rolling bearing 15 set by setting unit 202. Specifically, central processing unit 214 reads the plurality of constants Ca to Cd corresponding to the bearing model number set by setting unit 202 from DB unit 208 and restores coefficients Cin, Cout, and Crol in accordance with the expressions (10) to (12) from the read plurality of constants Ca to Cd. Then, central processing unit 214 calculates the BPFI, the BPFO, and the BSF in accordance with the expressions (7) to (9) based on restored coefficients Cin, Cout, and Crol and the rotation speed (or the rotation frequency) set by setting unit 202.

In the present third embodiment, for the peak for which the part has been specified, display 212 shows the peak value, the part, and the result of determination (“danger”, “caution”, “good”, and the like) by determination unit 210 on the screen of portable information terminal 30.

FIG. 11 is a diagram showing exemplary information set by setting unit 202 in the third embodiment. Information set by setting unit 202 can be entered by a user on the screen of portable information terminal 30, and FIG. 11 shows the screen of portable information terminal 30 for entry of information by the user.

Referring to FIG. 11, the bearing model number of rolling bearing 15 (FIG. 1) subjected to measurement can be entered in input section 310.

A rotation speed (min⁻¹) of the shaft in measurement can be entered in input section 320. Since vibration measurement system 10 is not provided with a sensor that detects the rotation speed of the shaft in measurement by measurement instrument 20, information on the rotation speed should be obtained and entered in input section 320 in measurement. When a rotation speed sensor is annexed, however, input section 320 does not have to be provided. The rotation frequency of the shaft in measurement instead of the rotation speed of the shaft in measurement may be entered in input section 320.

A criterion value (acceleration) to be used by determination unit 210 can be entered in input section 330. In the present third embodiment as well, the criterion value is set to a uniform value regardless of the peak frequency.

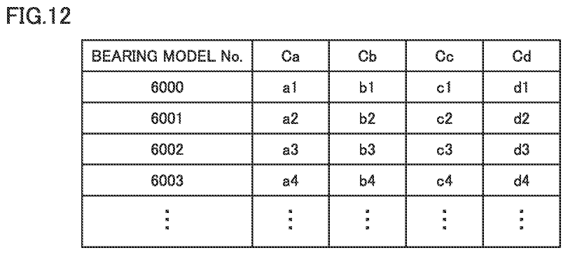

FIG. 12 is a diagram showing exemplary data stored in DB unit 208 in the third embodiment. Referring to FIG. 12, the plurality of constants Ca to Cd obtained by division of coefficients Cin, Cout, and Crol for calculating the BPFI, the BPFO, and the BSF are stored in DB unit 208 as being associated with the bearing model number for each bearing that can be subjected to vibration measurement by vibration measurement system 10. Even if such constants Ca to Cd may be leaked to the outside of portable information terminal 30, elucidation of the specifications of the bearing can be prevented.

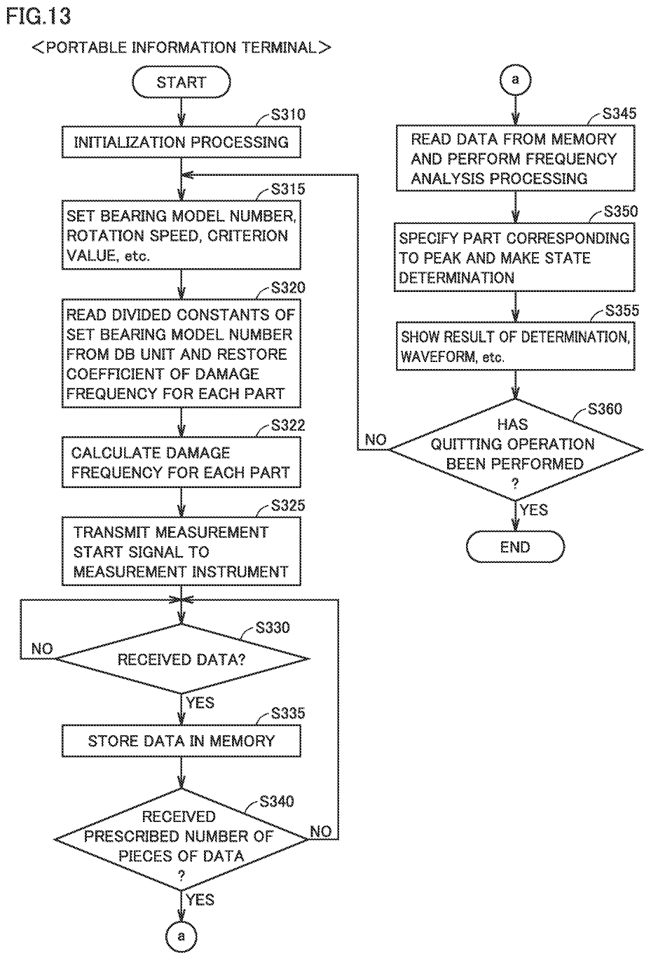

FIG. 13 is a flowchart showing an exemplary procedure in processing in portable information terminal 30. Referring to FIG. 3 together with FIG. 13, when application software for vibration measurement with the use of measurement instrument 20 is launched on portable information terminal 30 and start of measurement is indicated by means of the application software, central processing unit 214 performs prescribed initialization processing (step S310). In the initialization processing, for example, communication between communication unit 204 and measurement instrument 20 is established and prescribed resetting processing is performed.

Then, in response to an instruction from central processing unit 214, setting unit 202 sets the bearing model number of rolling bearing 15 subjected to measurement, the rotation speed (or the rotation frequency) in measurement, the criterion value for determining the vibration state based on measurement data, and the like (step S315). Each set value is entered by a user on the screen of portable information terminal 30.

Then, central processing unit 214 reads constants Ca to Cd (divided constants) of the bearing corresponding to the set bearing model number from DB unit 208 and restores coefficients Cin, Cout, and Crol in accordance with the expressions (10) to (12) from read constants Ca to Cd (step S320).

Then, central processing unit 214 calculates the BPFI, the BPFO, and the BSF of rolling bearing 15 subjected to measurement in accordance with the expressions (7) to (9) based on restored coefficients Cin, Cout, and Crol and the rotation frequency calculated from the rotation speed set in step S315 (step S322). Thereafter, central processing unit 214 transmits the measurement start signal to measurement instrument 20 through communication unit 204 (step S325).

When the measurement start signal is transmitted to measurement instrument 20, central processing unit 214 determines whether or not it has received measurement data (acceleration data) from measurement instrument 20 (step S330). Then, when central processing unit 214 has received the measurement data (YES in step S330), it has the received measurement data stored in the memory (not shown) (step S335).

Then, central processing unit 214 determines whether or not the number of pieces of measurement data received from measurement instrument 20 has reached a prescribed number (step S340). When the number of pieces of data has not reached the prescribed number (NO in step S340), the central processing unit repeats processing in steps S330 and S335.

When central processing unit 214 determines in step S340 that the number of pieces of data has reached the prescribed number (YES in step S340), it reads data from the memory and has analyzer 206 conduct frequency analysis of data (acceleration data) obtained by measurement by measurement instrument 20 (step S345). Specifically, fast Fourier transform (FFT) processing is performed on time-series acceleration data obtained by measurement by measurement instrument 20 to obtain a frequency spectrum of obtained acceleration data.

Then, for peaks in the obtained frequency spectrum, central processing unit 214 specifies from which of a fault of the inner ring, a fault of the outer ring, a fault of the rolling element, imbalance of the shaft, and misalignment the peak is derived based on whether or not the peak frequency matches with any of the BPFI, the BPFO, the BSF, and a higher-order component thereof or whether or not it matches with any of the rotation frequency of the shaft, the frequency twice as high as that, and a higher-order component thereof. Then, for each specified part, central processing unit 214 has determination unit 210 determine the vibration state of each part based on the criterion value set in step S315 (step S350).

For example, determination unit 210 determines a peak having the peak value exceeding the criterion value as “danger”. Determination unit 210 determines a peak having the peak value smaller than the criterion value but exceeding eighty percent of the criterion value as “caution” and determines a peak having the peak value smaller than eighty percent of the criterion value as “good”.

Then, central processing unit 214 has display 212 show the result of determination in step S350, the peak value, the peak frequency, and the part on the screen of portable information terminal 30, together with a waveform of the frequency spectrum (step S355).

Then, central processing unit 214 determines whether or not the user has performed the quitting operation to quit measurement (step S360). When the central processing unit determines that the quitting operation has not been performed (NO in step S360), the process returns to step S315. When the central processing unit determines that the quitting operation has been performed (YES in step S360), the process proceeds to end and a series of processing in portable information terminal 30 ends.

As set forth above, in this third embodiment, coefficients Cin, Cout, and Crol for calculating the BPFI, the BPFO, and the BSF are stored in DB unit 208 as being divided into the plurality of constants Ca to Cd. Then, in vibration analysis, constants Ca to Cd are read from DB unit 208 to restore coefficients Cin, Cout, and Crol, and the BPFI, the BPFO, and the BSF are calculated based on restored coefficients Cin, Cout, and Crol. Thus, elucidation of specifications of the bearing that can be subjected to measurement by vibration measurement system 10 in the event of leakage of data (constants Ca to Cd) stored in DB unit 208 to the outside of portable information terminal 30 can be prevented. Therefore, according to this third embodiment, leakage of specification data of the bearing can be prevented.

Since measurement instrument 20 and portable information terminal 30 wirelessly communicate with each other also in this third embodiment, the user can check a result of vibration analysis at any location within an area where wireless communication can be established simply by installing measurement instrument 20 in a measurement target.

### Fourth Embodiment

In the third embodiment, each of coefficients Cin, Cout, and Crol used for calculation of the BPFI, the BPFO, and the BSF is stored in DB unit 208 as being divided into the plurality of constants Ca to Cd. In this fourth embodiment, specification data (diameter D of the pitch circle of the bearing, diameter d of the rolling element, contact angle α of the rolling element, and the number Z of rolling elements) of rolling bearing 15 subjected to measurement is stored in DB unit 208 as being encrypted. Then, in measurement, the encrypted specification data is read from DB unit 208 and decrypted to calculate the BPFI, the BPFO, and the BSF.

An overall configuration of the vibration measurement system according to this fourth embodiment is similar to that in the first embodiment shown in FIGS. 1 and 2.

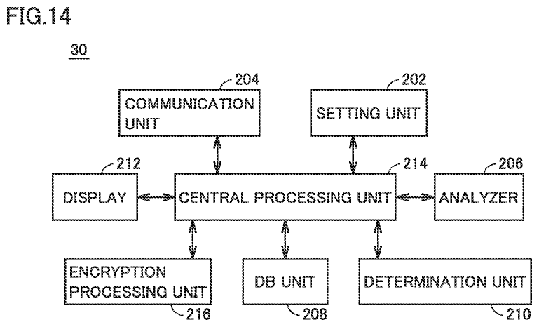

FIG. 14 is a diagram showing a configuration of portable information terminal 30 in the fourth embodiment. Referring to FIG. 14, in portable information terminal 30 in the first embodiment shown in FIG. 3, portable information terminal 30 in the fourth embodiment further includes an encryption processing unit 216.

In the present fourth embodiment, for various bearings that can be subjected to vibration measurement by vibration measurement system 10, specification data encrypted in accordance with prescribed cryptography is stored in DB unit 208 as being associated with bearing model numbers. Symmetric key cryptography or public key cryptography may be adopted as cryptography. Encryption may be done by using identical key encryption for various specifications or by using key encryption different for each specification. Various known approaches can be used for cryptography.

Then, in response to an instruction from central processing unit 214, encryption processing unit 216 reads specification data (encrypted data) corresponding to the bearing model number set by setting unit 202 from DB unit 208 and decrypts the read specification data by using key encryption in accordance with the cryptography.

Central processing unit 214 calculates the BPFI, the BPFO, and the BSF in accordance with the expressions (7) to (9) based on the specification data decrypted by encryption processing unit 216 and the rotation speed (or the rotation frequency) set by setting unit 202. Processing by central processing unit 214 after calculation of the BPFI, the BPFO, and the BSF is the same as in the third embodiment.

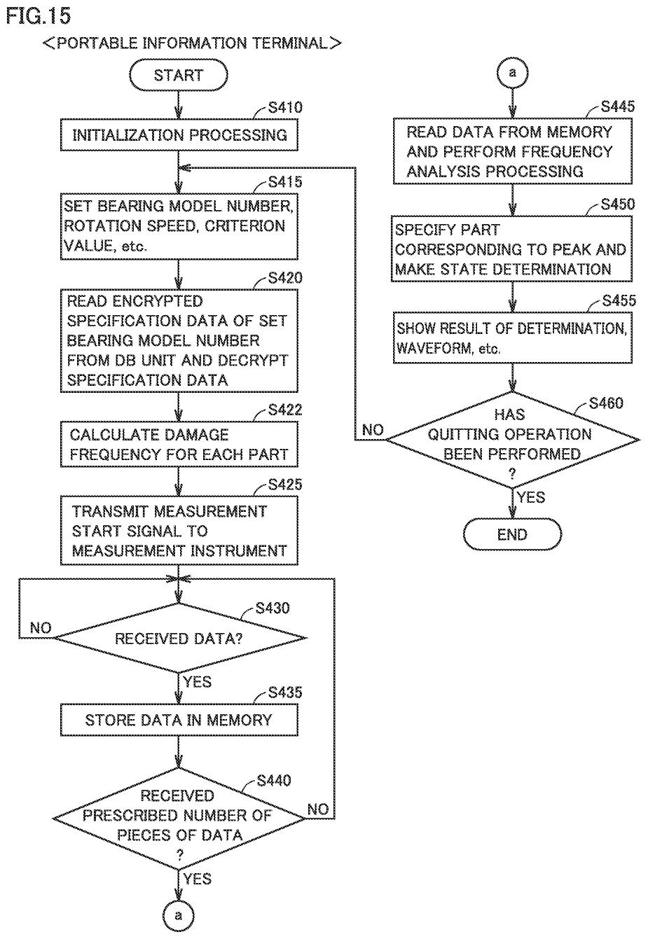

FIG. 15 is a flowchart showing an exemplary procedure in processing in portable information terminal 30 in the fourth embodiment. Referring to FIG. 14 together with FIG. 15, in the fourth embodiment as well, when application software for vibration measurement with the use of measurement instrument 20 is launched on portable information terminal 30 and start of measurement is indicated by means of the application software, central processing unit 214 performs prescribed initialization processing (step S410). Thereafter, setting unit 202 sets the bearing model number of rolling bearing 15 subjected to measurement, the rotation speed (or the rotation frequency) in measurement, the criterion value for determining the vibration state based on measurement data, and the like (step S415). Processing performed in steps S410 and S415 is the same as the processing performed in steps S310 and S315 in FIG. 13.

Then, the specification data (encrypted data) of the bearing corresponding to the set bearing model number is read from DB unit 208, and encryption processing unit 216 decrypts the encrypted specification data by using key encryption in accordance with prescribed cryptography (step S420).

Then, central processing unit 214 calculates the BPFI, the BPFO, and the BSF of rolling bearing 15 subjected to measurement in accordance with the expressions (7) to (9) based on the decrypted specification data and the rotation frequency calculated from the rotation speed set in step S415 (step S422).

When the BPFI, the BPFO, and the BSF are calculated in step S422, the process proceeds to step S425. Since processing in steps S425 to S455 is the same as the processing in steps S325 to S355 in FIG. 13, description will not be repeated.

As representation by display 212 is provided in step S455, central processing unit 214 determines whether or not the user has performed the quitting operation to quit measurement (step S460). When the central processing unit determines that the quitting operation has not been performed (NO in step S460), the process returns to step S415. When the central processing unit determines that the quitting operation has been performed (YES in step S460), the process proceeds to end and a series of processing in portable information terminal 30 ends.

As set forth above, in this fourth embodiment, specification data of rolling bearing 15 subjected to measurement is stored as being encrypted in DB unit 208. Then, in vibration analysis, the encrypted specification data is read from DB unit 208 and decrypted, and the BPFI, the BPFO, and the BSF are calculated based on the decrypted specification data. Thus, elucidation of the specifications of the bearing that can be subjected to measurement by vibration measurement system 10 in the event of leakage of data (encrypted specification data) stored in DB unit 208 to the outside of portable information terminal 30 can be prevented. Therefore, according to this fourth embodiment as well, leakage of specification data of the bearing can be prevented.

Since measurement instrument 20 and portable information terminal 30 wirelessly communicate with each other also in this fourth embodiment, the user can check a result of vibration analysis at any location within an area where wireless communication can be established simply by installing measurement instrument 20 in a measurement target.

Though the specification data of the measurement target is stored in DB unit 208 as being encrypted in the fourth embodiment, coefficients Cin, Cout, and Crol for calculating the BPFI, the BPFO, and the BSF may be stored in DB unit 208 as being encrypted, or the plurality of constants Ca to Cd obtained by division of coefficients Cin, Cout, and Crol described in the third embodiment may be stored in DB unit 208 as being encrypted.

In the third embodiment, the plurality of constants Ca to Cd may be stored in DB unit 208 in a binary format. Elucidation of the specifications of the bearing that can be subjected to measurement by vibration measurement system 10 in the event of leakage of data stored in DB unit 208 to the outside of portable information terminal 30 can thus also be prevented.

Furthermore, in the fourth embodiment, the specification data in the binary format may be stored in DB unit 208 as being encrypted. Alternatively, coefficients Cin, Cout, and Crol in the binary format or the plurality of constants Ca to Cd in the binary format may be stored in DB unit 208 as being encrypted.

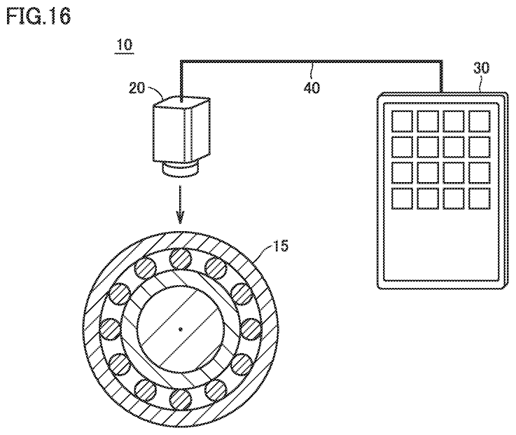

Though measurement instrument 20 and portable information terminal 30 wirelessly communicate with each other in each embodiment above, measurement instrument 20 and portable information terminal 30 may be connected to each other through a communication line 40 as shown in FIG. 16, and measurement instrument 20 and portable information terminal 30 may communicate with each other through communication line 40.

Combination as appropriate of the embodiments disclosed herein is originally intended so long as such combination is not technically inconsistent. It should be understood that the embodiments disclosed herein are illustrative and non-restrictive in every respect. The scope of the present invention is defined by the terms of the claims rather than the description of the embodiments above and is intended to include any modifications within the scope and meaning equivalent to the terms of the claims.

### REFERENCE SIGNS LIST

10 vibration measurement system; 15 measurement target (rolling bearing); 20 measurement instrument; 30 portable information terminal; 40 communication line; 102 acceleration sensor; 104 antialiasing filter; 106 A/D converter; 108 microcomputer; 110 memory; 112 communication module; 202 setting unit; 204 communication unit; 206 analyzer; 208 DB unit; 210 determination unit; 212 display; 214 central processing unit; 216 encryption processing unit; 310 to 340, 410 to 460 input section

1. A vibration analysis apparatus that receives measurement data from a measurement instrument and conducts vibration analysis, the measurement instrument measuring vibration of a rotating body subjected to measurement, the vibration analysis apparatus comprising:
a setting unit that sets information on the rotating body and a criterion value for diagnosing a vibration state of the rotating body;
an analyzer that conducts frequency analysis of the measurement data received from the measurement instrument;
a processor that specifies, for a prescribed number of peaks largest in peak value in a descending order in a frequency spectrum obtained by the frequency analysis, a part based on the information on the rotating body;
a determination unit that determines, for the prescribed number of peaks, the vibration state based on the peak value and the criterion value; and
a display that shows, for the prescribed number of peaks, the peak value, the part, and a result of determination by the determination unit.

2. The vibration analysis apparatus according to claim 1, wherein
the prescribed number is set by a user who uses the vibration analysis apparatus.

3. A vibration analysis apparatus that receives measurement data from a measurement instrument and conducts vibration analysis, the measurement instrument measuring vibration of a rotating body subjected to measurement, the vibration analysis apparatus comprising:
a setting unit that sets information on the rotating body, a plurality of frequency bands for which vibration analysis is conducted, and a plurality of criterion values provided in correspondence with the plurality of frequency bands, respectively;
an analyzer that conducts frequency analysis of the measurement data received from the measurement instrument;
a determination unit that determines, in each frequency band of the plurality of frequency bands, a vibration state in the frequency band based on a peak value of a frequency spectrum obtained by the frequency analysis and a criterion value corresponding to the frequency band; and
a processor that controls processing of the setting unit, the analyzer and the determination unit.

4. The vibration analysis apparatus according to claim 3, wherein
the plurality of frequency bands are set by a user who uses the vibration analysis apparatus.

5. The vibration analysis apparatus according claim 1, further comprising a database unit in which a coefficient of a rotation frequency of the rotating body is stored as being divided into a plurality of constants, the coefficient being for calculating a damage frequency representing a frequency of vibration periodically produced in accordance with a damaged part of the rotating body, wherein
in the vibration analysis, the processor further reads the plurality of constants from the database unit to restore the coefficient and calculates the damage frequency based on the restored coefficient.

6. The vibration analysis apparatus according to claim 5, wherein
in the database unit, encrypted data resulting from encryption of the plurality of constants is stored, and
the processor reads the encrypted data from the database unit to decrypt the encrypted data and restores the coefficient from the plurality of constants that have been decrypted.

7. The vibration analysis apparatus according to claim 5, wherein
the plurality of constants are stored in the database unit in a binary format.

8. The vibration analysis apparatus according to claim 1, further comprising a database unit in which encrypted data resulting from encryption of specification data of the rotating body is stored, wherein
in the vibration analysis, the processor further reads the encrypted data from the database unit to decrypt the encrypted data, and calculates a damage frequency representing a frequency of vibration periodically produced in accordance with a damaged part of the rotating body based on the specification data that has been decrypted.

9. The vibration analysis apparatus according to claim 8, wherein
in the database unit, the encrypted data resulting from encryption of the specification data in a binary format is stored.

10. A The vibration analysis apparatus according to claim 1, wherein
the rotating body is a bearing.

11. The vibration analysis apparatus according to claim 10, wherein
the information on the rotating body includes
a rotation speed or a rotation frequency of the bearing, and
a specification of the bearing or a coefficient of the rotation frequency used for calculation of a BPFI, a BPFO, and a BSF of the bearing.

12. The vibration analysis apparatus according to claim 1, further comprising a communication unit that wirelessly communicates with the measurement instrument.

13. A vibration measurement system comprising:
a measurement instrument that measures vibration of a rotating body subjected to measurement; and
the vibration analysis apparatus according to claim 1 that receives measurement data from the measurement instrument and conducts vibration analysis.

14. The vibration analysis apparatus according to claim 5, wherein
the rotating body is a bearing.

15. The vibration analysis apparatus according to claim 14, wherein
the information on the rotating body includes
a rotation speed or a rotation frequency of the bearing, and
a specification of the bearing or a coefficient of the rotation frequency used for calculation of a BPFI, a BPFO, and a BSF of the bearing.

16. The vibration analysis apparatus according to claim 5, further comprising a communication unit that wirelessly communicates with the measurement instrument.

17. A vibration measurement system comprising:
a measurement instrument that measures vibration of a rotating body subjected to measurement; and
the vibration analysis apparatus according to claim 5 that receives measurement data from the measurement instrument and conducts vibration analysis.

18. The vibration analysis apparatus according claim 3, further comprising a database unit in which a coefficient of a rotation frequency of the rotating body is stored as being divided into a plurality of constants, the coefficient being for calculating a damage frequency representing a frequency of vibration periodically produced in accordance with a damaged part of the rotating body, wherein
in the vibration analysis, the processor further reads the plurality of constants from the database unit to restore the coefficient and calculates the damage frequency based on the restored coefficient.

19. The vibration analysis apparatus according to claim 3, further comprising a database unit in which encrypted data resulting from encryption of specification data of the rotating body is stored, wherein
in the vibration analysis, the processor further reads the encrypted data from the database unit to decrypt the encrypted data, and calculates a damage frequency representing a frequency of vibration periodically produced in accordance with a damaged part of the rotating body based on the specification data that has been decrypted.
